(19) United States
(12) Patent Application Publication
(10) Pub. No.: US 2007/0209433 A1
(43) Pub. Date: Sep. 13, 2007

(54) Thermal mass gas flow sensor and method of forming same

(75) Inventors: Richard W. Gehman, Freeport, IL (US); Anthony M. Dmytriw, Freeport, IL (US); Christopher M. Blumhoff, Dixon, IL (US); Stephen R. Shiffer, Xenia, OH (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/373,947

(22) Filed: Mar. 10, 2006

(51) Int. Cl. G01F 1/68

(52) U.S. Cl. 73/204.26

(57) ABSTRACT

A thermal gas flow sensor and method of forming such a sensor. The sensor has a substrate and a heater disposed on the substrate. At least one pair of thermal sensing elements is disposed on the substrate either side of the heater. A protective layer is disposed on at least the heater and/or the thermal sensing elements. The protective layer comprises a high temperature resistant polymer based layer which is preferably a fluoropolymer based layer. The protective layer can also cover interconnects and electrical connections also formed on the substrate so as to completely seal the sensor. A passivation layer, such as silicon nitride, can be disposed on the sensing and/or heating elements and optionally the interconnects and is arranged to interpose the protective layer and the substrate.

### TECHNICAL FIELD

Embodiments are generally related to flow sensors, and in particular, to thermal mass gas flow sensors, such as thermal air flow sensors, and methods of manufacturing such thermal gas flow sensors. Embodiments are additionally related to thermal gas flow sensors in the form of MEMS devices.

### BACKGROUND OF THE INVENTION

Thermal mass gas flow sensors in the form of MEMS devices are configured to measure properties of a gas, such as air, in contact with the sensors and provide output signals representative of the gas flow rates. Thermal mass gas flow sensors are configured to heat the gas and measure the resulting thermal properties of the gas to determine flow rates. Such thermal flow sensors generally include a microsensor die consisting of a substrate and one or more elements disposed on the substrate for heating the gas and sensing the gas thermal properties. A microbridge gas flow sensor, such as the device detailed in U.S. Pat. No. 4,651,564 to Johnson et al., is an example of a thermal mass gas flow sensor.

The microbridge sensor includes a flow sensor chip which has a thin film bridge structure thermally insulated from the chip substrate. A pair of temperature sensing resistive elements are arranged on the upper surface of the bridge either side of a heater element such that, when the bridge is immersed in the gas stream, the flow of the gas cools the temperature sensing element on the upstream side and promotes heat conduction from the heater element to thereby heat the temperature sensing element on the downstream side. The temperature differential between the upstream and downstream sensing elements, which increases with increasing flow speed, is converted into an output voltage by incorporating the sensing elements in a Wheatstone bridge circuit such that the flow speed of the gas can be detected by correlating the output voltage with the flow speed. When there is no gas flow, there is no temperature differential because the upstream and downstream sensing elements are at similar temperatures.

Unfortunately, thermal mass gas flow meters, in particular thermal mass air flow sensors, are susceptible to damage caused by repeated or long term exposure to liquid resulting from condensation or immersion in liquids. This damage is especially severe and rapid if the liquid is electrically conductive, example being impure water.

The aforementioned problem demonstrates that there is a need to provide an improved thermal gas flow sensor which is less susceptible to failure in the sensing environment.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect to provide for an improved thermal mass gas flow sensor.

It is another aspect, to provide for a more reliable thermal mass gas flow sensor.

The aforementioned aspects of the invention and other objectives and advantages can now be achieved as described herein.

According to one aspect, a thermal mass gas flow sensor can include a substrate and at least one pair of thermal sensing elements disposed on the substrate. A heater is also disposed on the substrate between the thermal sensing elements. The thermal mass gas flow sensor can have different configurations such as a microbridge configuration or a microbrick configuration. A protective layer is disposed on at least the heater and/or the thermal sensing elements. The protective layer comprises a high temperature resistant insulating or dielectric layer, such as for example a high temperature resistant polymer based layer such as a fluoropolymer thin film.

The protective layer minimizes corrosion and dendritic growth caused by exposure of the sensor to liquid, especially water or other electrically conductive liquids, thereby maximizing the reliability of the thermal gas flow sensor.

If necessary, a dielectric or insulating passivation layer can be disposed on the sensing elements and the heater so that the passivation layer interposes the protective layer and the substrate.

The protective layer is preferably a high temperature polymer based layer such as a fluoropolymer. For example, the protective layer can be a polytetrafluoroetheylene (PTFE) or a fluorinated parylene thin film.

By providing a fluoropolymer protective layer on the sensing and heater elements, electrochemical reaction between the elements and the water is suppressed so that degradation of the elements by the water is minimized. A substantially waterproof thermal mass gas flow meter is therefore provided. Furthermore, if the protective layer is also hydrophobic, as in the case of the PTFE layer, then protection will be enhanced and recovery from exposure to the water accelerated.

According to another aspect, a thermal gas micro flow sensor has a substrate and a heater disposed on the substrate. At least one pair of thermal sensing elements are disposed on the substrate, either side of the heater. A protective layer is disposed on at least the heater and/or the thermal sensing elements. The protective layer comprises a high temperature resistant polymer based layer.

The sensor can include electrical interconnects, disposed on the substrate, electrically connected to the thermal sensing elements and the heater. The protective layer can also be disposed on the electrical interconnects.

Conductive links or wires can be electrically connected to the interconnects for connecting the temperature sensing elements and the heater to external circuitry. The protective layer can also be disposed on these wire connections. Advantageously, the protective layer can be formed on all the electrical elements on the substrate including the wire connections thereby completely sealing the sensor.

The sensor can include a passivation layer, such as a silicon nitride layer (SiNx), formed on the thermal sensing elements and heater, and optionally the interconnects. The passivation layer is arranged to interpose the substrate and the protective layer.

The substrate can have a microbridge structure formed thereon and the thermal sensing elements and heater can be disposed on the microbridge structure thereby forming a microbridge flow sensor. Alternatively, the substrate can be fabricated in the form of a microbrick structure providing a substantially solid structure beneath the temperature and heating elements.

The protective layer can be at least one fluoropolymer selected from the group consisting of polytetrafluoroetheylene and fluorinated parylene.

According to yet another embodiment, a method of manufacturing a thermal mass gas flow sensor comprises providing a substrate, forming at least one pair of temperature sensing elements on the substrate, forming a heating element on the substrate between the at least one pair of temperature sensing elements, and forming a protective layer on at least the temperature sensing elements and/or the heating elements, wherein the protective layer comprises a high temperature resistant polymer based layer.

The method of forming the protective layer can comprise vapor depositing a fluoropolymer thin film on the sensing and heating elements.

The method can further comprise forming electrical interconnections on the substrate for passing signals between the sensor and external circuitry, and forming the protective layer also on the electrical interconnections.

The method can further comprise depositing a passivation layer on the sensing and heating elements and optionally the electrical interconnections preparatory to forming the protective layer.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a thermal mass gas flow sensor according to a preferred embodiment;

FIG. 2 illustrates a cross-sectional view taken along line A-A of FIG. 1 with wires bonded to the sensor;

FIG. 3 illustrates a perspective view of a thermal mass gas flow sensor according to another embodiment; and

FIG. 4 illustrates a cross-sectional view taken along line A-A of FIG. 3 with wires bonded to the sensor.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

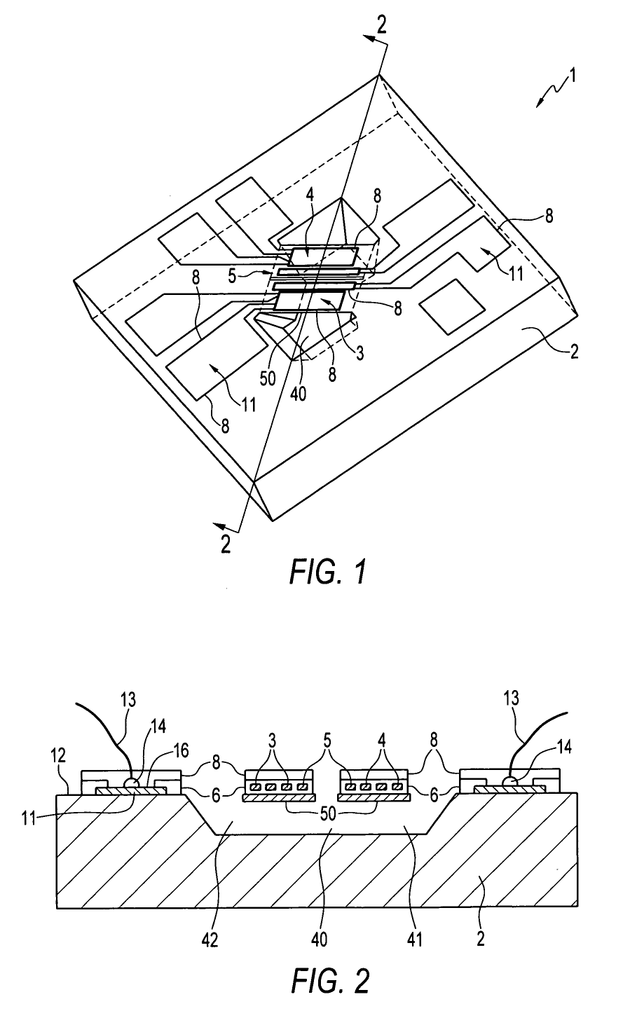

Referring to the accompanying drawings, FIG. 1 illustrates a perspective view taken from above the thermal mass gas flow sensor according to one embodiment and FIG. 2 illustrates a cross-sectional view taken along line A-A of FIG. 1 with wires bonded to the sensor. As a general overview, the thermal mass gas flow sensor 1 has a substrate 2 and a heater 5 disposed on the substrate 2 between a pair of thermal sensing elements 3, 4, also disposed on the substrate. A protective layer 8 is disposed on the heater 5 and thermal sensing elements 3, 4. The protective layer 8 is formed from a high temperature resistant insulating or dielectric layer which is preferably an organic layer such as a polymer based layer. For the reasons explained in more detail below, the protective layer minimizes corrosion and dendritic growth caused by exposure of the sensor to liquid, especially water or other electrically conductive liquids, thereby maximizing the reliability of the thermal gas flow sensor 1.

In the illustrative embodiment of the thermal mass gas flow sensor shown in FIGS. 1 & 2, the flow sensor 1 is configured as a microbridge air flow sensor chip 1, for example, as disclosed in U.S. Pat. No. 5,050,429, entitled “Microbridge flow sensor”, issued to Nishimoto et al on Sep. 24, 1991. This sensor has many advantageous features, e.g., a very high response speed, high sensitivity, low power consumption, and good mass productivity.

The microbridge sensor 1 has a thin-film bridge structure 50 having a very small heat capacity formed on the substrate 2 by a thin-film forming technique and an anisotropic etching technique as is known in the art. The substrate 2 is typically formed from silicon; however, the substrate can be formed from other semiconductors or other suitable materials, such as ceramic materials. A through hole 40 is formed in the central portion of the substrate 2 by the anisotropic etching so as to communicate with left and right openings 41, 42. The bridge portion 50 can be integrally formed above the through-hole 40 so as to be spatially isolated from the substrate 2 in the form of a bridge. As a result, the bridge portion 50 is thermally insulated from the substrate 2. The thermal sensing elements 3, 4 and heater 5 therebetween are formed as thin-film elements arranged on the upper surface of the bridge portion 50.

Thermal sensing and heating elements 3, 4, 5 are in the form of resistive grid structures which are fabricated from suitable metal, such as platinum or a permalloy. Alternatively, chrome silicon (CrSi) or doped silicon thin film resistors or other types of silicon-based resistors can be employed as the sensing and heating elements 3, 4, 5 instead of metal. Electrical interconnects 11, which comprise conductive contact pads, are arranged on a peripheral region of the substrate upper surface 12 in electrical contact with the sensing and heating elements. Wires 13 or conductive links can be electrically connected to the conductive pads 11 by means of conductive wire bonding 14, for example by soldering as is known in the art, so as to form electrical interconnections enabling electrical signals to be passed between the sensing/heating elements 3,4,5 and external circuitry (see FIG. 2). Alternatively, conductive vias can be formed through the substrate for electrically interconnecting the heater and/or elements 3, 4, 5 to other components on the opposite side of the substrate.

The protective layer 8 is formed on the upper surface of the bridge portion 50 so as to cover the sensing and heating elements 3, 4, 5. The protective layer 8 has a substantially high electrical resistance to suppress electrochemical reaction, while being as thin as possible to substantially minimize added thermal mass which will desensitize the sensor. The protective layer 8 can be selectively disposed on the sensing and heating elements 3, 4, 5 and, preferably, also the interconnects 11 and wire bonds 14 so that all electrical elements and electrical connections on the sensor are protected by the protective layer 8. Alternatively, the protective layer 8 can be applied on the entire upper surface of the sensor provided the layer 8 does not interfere with sensor assembly or electrical connection to external circuitry. The protective layer 8 can be selectively deposited on the sensor preparatory to wire bonding the electrical wires 14 to the conductive pads 11, if necessary.

Preferably, the protective layer 8 is disposed on a silicon nitride (SiNx) passivation layer 6 which encapsulates the heating/sensing elements 3,4,5 so that the silicon nitride layer 6 interposes the protective layer 8 and substrate 2 (see FIG. 2). Those skilled in the art would understand that the passivation layer 6 can be made from insulating or dielectric materials other than SiNx, such as ceramics. Openings or windows 16 are formed in portions of the passivation layer 6 covering the conductive pads 11 such that the wires 13 can be bonded to the upper surfaces of the pads 11. The protective layer 8 is preferably deposited on the windows 16 so as to seal the windows.

Such openings 16 are unnecessary if the interconnects 11 are electrically connected to components on the opposite side of the substrate using conductive vias formed through the substrate.

Alternatively, the encapsulating layer 6 can be omitted and the protective layer 8 can be disposed directly on the heating/sensing elements 3, 4, 5 and, if necessary, the interconnects 11.

In the illustrative embodiment of the thermal gas flow sensor 1 shown in FIGS. 1 & 2, the protective layer 8 is a fluoropolymer based thin film. Such fluoropolymer based protective layers are advantageous in that they are generally characterized by excellent dielectric properties, high chemical resistance to solutions, acids and bases and high performance even at temperatures which are significantly higher than 100° C. For example, the protective layer 8 can be a polytetrafluoroetheylene (PTFE) based thin film. PTFE is also known by name of Teflon which is a registered Trade Mark of E.I. Du Pont De Nemours and Company Corporation Delaware 1007 Market Street Wilmington Del. 19898.

The PTFE and other fluoropolymer thin films can be deposited by processes known in the art, for example, fluoropolymer thin film vapor deposition is disclosed in United States Patent Application Publication No. US2002/0182321 A1 of Mocella et al, published Dec. 5, 2002 and entitled “Fluoropolymer interlayer dielectric by chemical vapor deposition” and which is incorporated herein by reference. Deposition on low temperature substrates is preferred. Examples of suitable coating equipment for low temperature substrate deposition include coatings systems supplied by GVD Corporation of 9 Blackstone Street, Suite 1, Cambridge, Mass. 02139.

The PTFE film can be deposited to a thickness of less than about 150 μm (0.006 inches) and, preferably, less than about 25 μm (0.001 inch) thick. The thin film is as thin as possible while achieving substantially continuous coverage and substantially zero porosity. The PTFE film 8 can be deposited through a suitable mask to selectively deposit the film on the sensing and heating elements 3, 4, 5 and interconnects 11. PTFE is also a hydrophobic layer which aids greatly in electrically isolating the active elements 3, 4 and 5. In addition, hydrophobicity speeds the drying of the sensor after exposure to liquids.

Other high temperature resistant insulating or dielectric layers can be used as the protective layer 8 instead of the PTFE film 8. For example, the protective layer can be a fluorinated parlyene compound. Fluorinated parlyene can be deposited by parlyene vapor deposition processes know in the art, for example, such processes are disclosed in U.S. Pat. No. 5,908,506, entitled “Continuous vapor deposition”, issued to Olson et al on Jun. 1, 1999 and incorporated herein by reference. Examples of fluorinated parlyene include parlyene HT, supplied by Specialty Coatings Systems (SCS) of 7645 Woodland Drive Indianapolis, Ind. 46278. Parlyene HT can operate continuously at temperatures as high as 350° C. and provides excellent solvent and dielectric protection as well as minimal mechanical stress. Parlyene HT can be vapor deposited on the sensor by means of coating apparatus supplied by SCS.

It has been determined that failures in existing mass flow gas sensors due to repeated or long term exposure to water and other electrically conductive liquids are primarily caused by either galvanic corrosion of the sensing and heating elements causing electrical openings or dendritic growth on the sensor surface. Short term failure is also due to short circuits through the conductive liquid. The protective layer 8 is a high temperature resistant layer which is defined herein as being a layer resistant to temperatures substantially higher than the boiling point of water, so that hot spots created by exposure to hot or boiling water or other liquids are substantially eliminated. Consequently, galvanic corrosion and dendritic growth are substantially minimized so that the flow sensor 1 is more stable and less prone to failure than existing mass gas flow sensors.

By providing the protective layer 8 on the sensing and heater elements, electrochemical reaction between the elements and the water is suppressed so that degradation of the elements by the water is minimized. A substantially waterproof thermal mass gas flow meter is therefore provided. Furthermore, if the protective layer is also hydrophobic, for example as in the case of the PTFE layer 8 of the illustrative embodiment, then protection is enhanced and recovery from exposure to the water accelerated.

Fabrication of the flow sensor without the protective layer thereon can be implemented by means of semiconductor and integrated circuit fabrication techniques apparent to those skilled in the art. Preferably, the sensor is mass produced by means of wafer level processing techniques, then the protective layer is deposited on the flow sensors which are subsequently singulated, that is, separated from adjacent packages, using known wafer dicing methods. The sensor chips are then assembled and packaged using standard Surface Mounting PCB or Hybrid microcircuit techniques

A method of fabricating a thermal mass gas flow sensor according to one embodiment will now be described with reference to the exemplary flow sensor of FIGS. 1 & 2. As a general overview the silicon substrate 2 is initially provided and the pair of temperature sensing elements 3, 4, heating element 5 and interconnects 11 are deposited on the substrate as is known in the art. Thereafter, the protective layer 8 comprising a high temperature resistant dielectric layer is formed on the temperature and heating elements and, preferably, the interconnects. Preferably, the protective layer 8 comprises a fluoropolymer layer as described above with reference to the sensor of FIG. 1. The protective layer 8 can be formed preparatory or subsequent to bonding wires 13 to the interconnects 11.

The protective layer 8 can be deposited directly in contact with the sensing and heating elements 3, 4, 5 and interconnect 11. Preferably, however, a SiNx or other suitable insulating or dielectric passivation layer 6 is first deposited on the substrate 2 so as to encapsulate the sensing and heating elements 3,4,5, (see FIG. 2). The SiNx layer 6 is advantageous in that it minimizes the diffusion of moisture to the sensing and heating elements 3, 4, 5. The SiNx layer 6 can be deposited by chemical vapor deposition (CV), low pressure chemical vapor deposition (LPCVD); plasma enhanced chemical vapor deposition (PECVD), sputtering or other known techniques. The required SiNx layer thickness is typically of the order of 8000 Å.

Thereafter, portions of the SiNx layers 6 covering the interconnecting interconnect pads 11 are etched back so as to form openings or windows 16 above the pads. Etching back of the SiNx can be performed by patterning a photoresist applied to the substrate and subsequently plasma etching the exposed SiNx back to the bonding pads 11, as is known in the art. The photoresist can then be removed via plasma and wet positive resist strip. Wires 13 or links for electrically connecting the heating and sensing elements to external circuitry are then electrically connected to the interconnect pads 11 by wire bonding 14.

Etching back the SiNx layer 6 is unnecessary if through the wafer conductive vias, rather than conductive pads 11, are formed in the substrate so as to connect the sensing and heating elements 3, 4, 5 to components on the underside of the substrate.

The protective layer 8 is then vapor deposited on the passivation layer 6 above the sensing and heating elements 3,4,5, and interconnects 11 and on the windows 16 in direct contact with the wire bonding 12 and exposed portions of the interconnect pads.

Etching back the SiNx layer 6 is unnecessary if through the wafer conductive vias, rather than conductive pads 11, are formed in the substrate so as to connect the sensing and heating elements 3, 4, 5 to components on the underside of the substrate.

Those skilled in the art would understand that the illustrations of FIGS. 1 & 2 are merely depicting one example of the embodiments and that the embodiments are not limited thereto. Whilst the thermal mass gas flow sensor of the illustrative embodiment shown in FIGS. 1 & 2 consists of a microbridge flow sensor, the sensor can have structures other than a microbridge structure.

For example, the gas flow sensor can have a Microbrick® or microfill structure which is more suited for measuring gas flow properties under harsh environmental conditions. Note that the term Microbrick® is a registered trade mark of Honeywell Inc. of Morristown, N.J. The microstructure flow sensor uses a Microbrick® or micro fill forming a substantially solid structure beneath the heating/sensing elements. Examples of such microbrick thermal flow sensors are disclosed in U.S. Pat. No. 6,794,981 entitled “Integratable-fluid flow and property microsensor assembly” issued on Sep. 21, 2004 which is incorporated herein by reference.

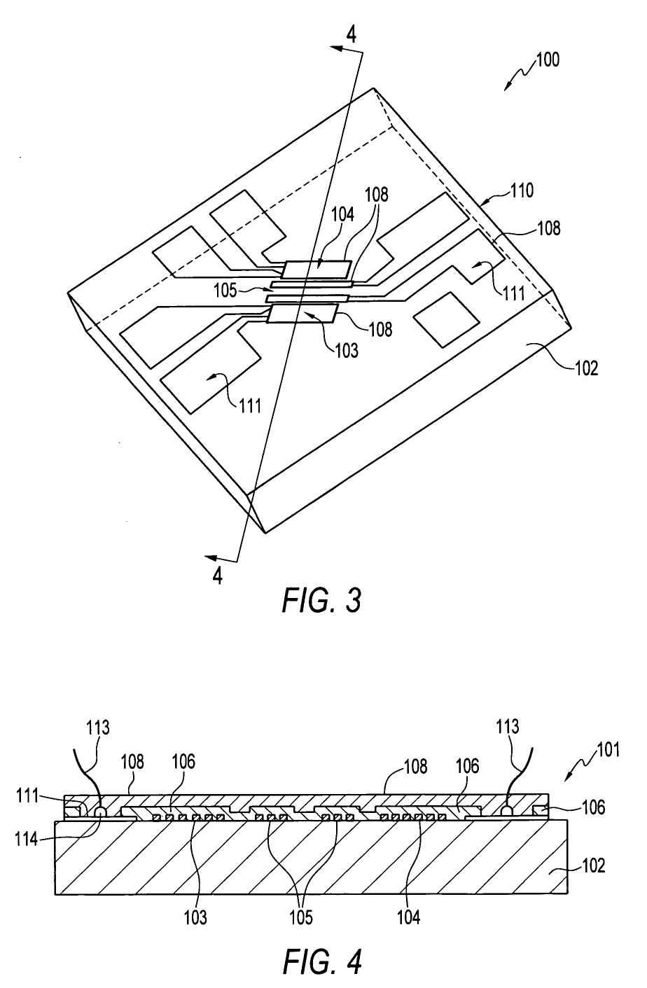

One example of a Microbrick a gas flow sensor is illustrated in FIGS. 3 which illustrates a perspective view taken from above a Mircobrick gas flow sensor according to one embodiment. FIG. 4 illustrates a cross-sectional view taken along line A-A of FIG. 3 with wires attached to the sensor. The gas flow sensor 100 according to one embodiment generally consists of a microstructure sensor die 110 having a substrate 102, a pair of temperature sensing resistive elements 103,104 formed on the substrate 102 and a heating resistive element 105, also formed on the substrate, between the temperature sensing elements. A protective layer 108, which is identical to the protective layer 8 of the gas flow sensor 1 of the first embodiment shown in FIG. 1, is selectively deposited so as to cover the sensing and heating elements 103,104,105 and preferably, the interconnect pads 111 and wire bonds 114.

Microsensor die 110 is fabricated in the form of a Microbrick® or microfill structure, such as detailed in U.S. Pat. No. 6,794,981. The microbrick structure consists of a block of material, preferably a low thermal conductivity material, such as for example fused silica, fused quartz, borosilicate glass, or other glassy materials, providing a substantially solid structure beneath the heating/sensing elements 103,104,105. Resistive elements 103,104,105 have grid structures fabricated from a suitable metal, such as platinum or a permalloy, interconnected to bonding contact pads 111, located on a peripheral region of the substrate 102, to which can be bonded wires 113 for passing signals between the elements and external circuitry. Alternatively, conductive vias can be formed through the substrate for electrically interconnecting the elements 103,104,105 to other components on the opposite side of the substrate. Chrome silicon (CrSi) or doped silicon thin film resistors or other types of silicon-based resistors can be employed as elements 103,104,105 instead of platinum.

In the illustrative embodiment shown in FIG. 1, the substrate 102 is fabricated from a glassy material so as to provide a more structurally robust gas flow sensor. In order to sense high mass flux flow rates, it is also advantageous to have a substrate material with a low thermal conductivity. If it is too low, the output signal saturates at moderate fluxes (1 g/cm<2>s); but if it is too high the output signal becomes too small. Certain glass materials provide better thermal isolation characteristics (than silicon), thus increasing the sensing capabilities of the above-outlined micromachined flow and property sensor. The use of glass also allows for a more robust physical structure to be used. These various characteristics result in a more versatile sensor which can be used in multiple applications.

Fabrication of the microsensor die 110 can be implemented by means of semiconductor and integrated circuit fabrication techniques apparent to those skilled in the art. Preferably, the microsensor die 110 is mass produced by means of wafer level processing techniques and subsequently singulated, which is, separated from adjacent packages, using known wafer dicing methods.

As in the case of the micro flow sensor of FIG. 1, preferably, the protective layer 108 is disposed on an insulating or dielectric passivation layer 106, such as for example silicon nitride, which encapsulates the heating/sensing elements 103,104,105 so that the silicon nitride layer 106 interposes the protective layer 108 and substrate 102 (see FIG. 4). However, the encapsulating layer 106 as shown in FIGS. 3 & 4 can be omitted and the protective layer 8 can be disposed directly on the heating/sensing elements 103,104,105.

The protective layer 108 can be formed from the same materials as protective layer 8 of the sensor of the first embodiment shown in FIG. 1 The advantages of protective layer 108 are the same as those of protective layer 8.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

For example, in the illustrative embodiments, the thermal gas flow sensors have pairs of temperature sensing elements and a heater, however, the thermal mass gas flow sensors can have any number of temperature sensing elements and/or heaters.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A thermal mass gas flow sensor, comprising:
a substrate and at least one pair of thermal sensing elements disposed on said substrate;
a heater, disposed on said substrate, between said thermal sensing elements; and
a protective layer disposed on at least said heater and/or said thermal sensing elements, wherein said protective layer comprises a high temperature resistant insulating or dielectric layer.

2. The sensor of claim 1, further comprising a dielectric or insulating passivation layer disposed on said sensing elements and said heater, said passivation layer interposing said protective layer and said sensing elements and said heater.

3. The sensor of claim 1, wherein said protective layer further comprises a polymer based layer.

4. The sensor of claim 3, wherein said sensor is configured as a microbridge or mircobrick gas flow sensor.

5. The sensor of claim 3, wherein said polymer comprises a fluoropolymer.

6. The sensor of claim 5, wherein said protective layer comprises at least one fluoropolymer selected from the group consisting of polytetrafluoroetheylene and fluorinated parylene.

7. The sensor of claim 1, wherein said protective layer is a hydrophobic layer.

8. A thermal gas micro flow sensor comprising:
a substrate;
a heater disposed on said substrate;
at least one pair of thermal sensing elements disposed on said substrate either side of said heater; and
a protective layer, disposed on at least said heater and/or said thermal sensing elements, wherein said protective layer comprises an high temperature resistant polymer based layer.

9. The sensor of claim 8, further comprising interconnects, disposed on said substrate, electrically connected to said thermal sensing elements and said heater, said protective layer also being disposed on said interconnects.

10. The sensor of claim 9, further comprising a passivation layer formed on said thermal sensing elements, said heater, and said interconnects, wherein said passivation layer interposes said substrate and said protective layer.

11. The sensor of claim 10, wherein said passivation layer has windows formed therein providing access to said interconnects and further comprising electrical connections comprising conductive links or wires electrically connected to said interconnects through said windows for connecting said temperature sensing elements and said heater to external circuitry, said protective layer sealing said windows and optionally said electrical connections.

12. The sensor of claim 11, wherein said passivation layer comprises a silicon nitride layer (SiNx).

13. The sensor of claim 11, wherein said substrate includes a microbridge structure formed thereon and wherein said thermal sensing elements and said heater are disposed on said microbridge structure thereby forming a microbridge flow sensor.

14. The sensor of claim 13, wherein said protective layer comprises at least one fluoropolymer selected from the group consisting of polytetrafluoroetheylene and fluorinated parylene

15. The sensor of claim 11, wherein said substrate is fabricated in the form of a microbrick structure providing a substantially solid structure beneath said temperature and heating elements.

16. The sensor of claim 15, wherein said protective layer comprises at least one fluoropolymer selected from the group consisting of polytetrafluoroetheylene and fluorinated parylene

17. A method of manufacturing a thermal mass gas flow sensor comprising:
providing a substrate;
forming at least one pair of temperature sensing elements on said substrate;
forming a heating element on said substrate between said at least one pair of temperature sensing elements, and
forming a protective layer on at least said temperature sensing elements and/or said heating elements, wherein said protective layer comprises a high temperature resistant polymer based layer.

18. The method of claim 17, wherein forming said protective layer, comprises vapor depositing a fluoropolymer thin film on said sensing and heating elements.

19. The method of claim 18, further comprising:
forming electrical interconnections on said substrate for passing signals between said sensor and external circuitry; and
forming said protective layer also on said electrical interconnections.

20. The method of claim 18, further comprising depositing a passivation layer on said sensing and heating elements preparatory to forming said protective layer.
